(19) United States
(12) Patent Application Publication
(10) Pub. No.: US 2012/0021309 A1
(43) Pub. Date: Jan. 26, 2012

(54) FUEL CELL SYSTEM

(75) Inventors: Osamu YUMITA, Nagoya-shi (JP); Yasuhiro NONOBE, Miyoshi-shi (JP)

(73) Assignee: TOYOTA JIDOSHA KABUSHIKI KAISHA, Toyota-shi (JP)

(21) Appl. No.: 13/243,898

(22) Filed: Sep. 23, 2011

Related U.S. Application Data
(63) Continuation of application No. PCT/JP2009/058395, filed on Apr. 28, 2009.

(51) Int. Cl. H01M 8/06

(52) U.S. Cl. 429/414

(57) ABSTRACT

A fuel cell system capable of inhibiting dew condensation in an area affected by freezing by providing an area for actively promoting dew condensation is provided. The fuel cell system includes a fuel cell and an off-gas passage for allowing an off-gas discharged from the fuel cell flow through, wherein a dew condensation promoting area for promoting dew condensation is placed around a freezing-affected area that will be adversely affected by freezing.

### TECHNICAL FIELD

The present invention relates to a fuel cell system. Particularly, the invention relates to a fuel cell system having an antifreezing function.

### BACKGROUND ART

It is known that when a fuel cell in a fuel cell system is activated in a low-temperature environment, activation of the fuel cell system may become difficult because, for example, water remaining in the fuel cell or pipes connected to the fuel cell may freeze, a gas flow in the fuel cell or the pipes may be blocked, and electric power generation may be stopped. For example, there is a fuel cell system configured so that a hydrogen gas detector is placed in an outlet pipe of a fuel cell on the cathode side in order to detect system anomalies. Since this hydrogen gas detector is exposed to gas containing moisture (for example, produced water or moistening water), there is a possibility that it may easily cause, for example, early degradation or reduction in detection accuracy.

Accordingly, a dew condensation prevention structure for a gas sensor has been introduced, which inhibits dew condensation in a gas sensor and prevents breakage, degradation, and detection accuracy reduction in the gas sensor by attaching a gas sensor for detecting gas to a passage, through which the detected gas flows, and placing a heater for heating the detected gas adjacent to, and upstream from, the gas sensor (for example, see Patent Document 1).

Another introduced fuel cell includes an electrolyte membrane, an anode separator having a hydrogen passage, a cathode separator having an air passage, and a coolant passage; and in which flooding is prevented by constituting at least one of the anode separator and the cathode separator from a conductive part and an insulating part and making the thickness of the insulating part thicker in areas where the hydrogen passage or the air passage may be blocked with flooding (for example, see Patent Document 2).

Furthermore, another introduced fuel cell system includes a fuel cell, a humidifier for humidifying gas supplied to the fuel cell, an air supply pipe connecting the fuel cell and the humidifier and serving as a passage for the supplied gas, and a sump trap placed in the air supply pipe; and problems caused by freezing of dew condensation water is avoided by retaining the dew condensation water, which is generated in the pipe, in the sump trap (see, for example, Patent Document 3).

Furthermore, another introduced fuel cell includes: an electricity generator; a separator which is layered on the electricity generator and has a first area overlapping with the electricity generator in the overlapping direction and a second area not overlapping with the electricity generator in the overlapping direction; and a thermal conduction member located to overlap with at least the second area of the separator in the overlapping direction. The fuel cell inhibits a temperature difference between the area overlapping with the electricity generator in the overlapping direction and the other area by making the thermal conductivity of the thermal conduction member higher than that of the separator (for example, see Patent Document 4).

### CITATION LIST

### Patent Documents

[Patent Document 1] Japanese Patent Application Laid-Open (Kokai) Publication No. 2004-69436

[Patent Document 2] Japanese Patent Application Laid-Open (Kokai) Publication No. 2006-134698

[Patent Document 3] Japanese Patent Application Laid-Open (Kokai) Publication No. 2007-317493

[Patent Document 4] Japanese Patent Application Laid-Open (Kokai) Publication No. 2008-226677

### DISCLOSURE OF THE INVENTION

### Problems to be Solved by the Invention

However, the dew condensation prevention structure disclosed in Patent Document 1 is configured so that the heater is provided in the passage, through which the detected gas containing a large amount of moisture flows, and the detected gas heated by the heater reaches the gas sensor located downstream. Therefore, it is necessary to always heat the detected gas with the heater. As a result, electric power consumption for heating is always required and there is a possibility that operational costs might increase.

Patent Document 2 discloses a fuel cell which inhibits flooding in cells of the fuel cell (individual fuel cells), but no consideration is given to prevention of dew condensation in a fuel cell stack or the fuel cell system.

With the fuel cell system disclosed in Patent Document 3, the pipe connecting the fuel cell and the humidifier is provided with the sump trap for retaining the dew condensation water generated in the pipe. However, no consideration is given to placing the sump trap at an optimum position, for example, placing the sump trap at a position where the dew condensation water can easily accumulate.

Furthermore, Patent Document 4 discloses inhibition of a temperature difference in the fuel cell, but no consideration is given to prevention of dew condensation in a fuel cell stack or the fuel cell system.

The present invention was devised in light of the circumstances described above. It is an object of the invention to provide a fuel cell system capable of inhibiting dew condensation at a site affected by freezing by providing an area for actively promoting dew condensation.

### Means for Solving the Problem

In order to achieve the above-described object, the present invention provides a fuel cell system including a fuel cell and an off-gas passage for allowing off-gas discharged from the fuel cell to flow through, wherein a dew condensation promoting area for promoting dew condensation is placed around a freezing-affected area that will be adversely affected by freezing.

Since the dew condensation promoting area for promoting dew condensation is placed around the freezing-affected area in the fuel cell system having the above-described configuration, dew condensation tends to be formed more easily in the dew condensation promoting area than the freezing-affected area. As a result, the amount of dew condensation in the freezing-affected area (amount of dew condensation water) can be made to be less than the amount of dew condensation in the dew condensation promoting area and .the freezing-affected area can be prevented from freezing due to the dew condensation water.

Incidentally, the phrase used in relation to this invention: the “freezing-affected area that will be adversely affected by freezing” means, for example, a comb-like passage connected to a gas supply manifold and gas discharge manifold, a common rail part, a pressure sensor, a valve, a compressor, or a manifold.

The dew condensation promoting area can be configured to have lower heat resistance than that of the freezing-affected area. As a result, the temperature of the dew condensation promoting area can be reduced to lower than the temperature of the freezing-affected area, so that dew condensation in the dew condensation promoting area can be further facilitated.

Moreover, with the fuel cell system according to this invention, the dew condensation promoting area can be provided with a buffer capable of temporarily retaining dew condensation water. Since the dew condensation water which has formed dew condensation in the dew condensation promoting area can be retained in the buffer by providing the buffer as described above, it is possible to, for example, prevent the dew condensation water from overflowing from the dew condensation area and moving through the off-gas passage and also prevent the moved dew condensation water from freezing and obstructing the off-gas passage.

Furthermore, the fuel cell system according to this invention can be configured so that the dew condensation promoting area is placed in the off-gas passage, and the buffer is placed in an area whose temperature becomes lower than a surrounding temperature (an area of a “valley-like acute decline portion” in a temperature distribution graph where the temperature is indicated on a vertical axis and the upper area of the vertical axis means a higher temperature) when temperature distribution in the off-gas passage is measured. Because of this configuration, the dew condensation water which has formed the dew condensation in the dew condensation promoting area can be retained in the buffer more efficiently.

Furthermore, the buffer in the fuel cell system according to this invention can be provided with a heater. If the heater is placed as described above, it is possible to, for example, heat only the precise spot of the buffer without heating the whole off-gas passage. As a result, temperature rise efficiency can be enhanced and energy costs required for heating can be reduced.

The volume of the buffer can be made equal to or more than an amount of water calculated from the amount of water vapor that can exist in the off-gas passage. As a result of configuring the buffer as described above, it is possible to reliably prevent the dew condensation water from overflowing from the buffer. The higher the operating temperature of the fuel cell is, the more the amount of water vapor increases. So, the optimum volume of the buffer should preferably be calculated (estimated) by using, for example, an equation of state of ideal gas based on temperature distribution at the highest operable temperature (T_{FCMAX}).

Also, the buffer can be placed in an upper area (relative to the direction of gravitational force) in the off-gas passage. If the buffer is placed as described above, when the dew condensation water which was frozen in the buffer is defrosted, the dew condensation water falls downwards (relative to the direction of gravitational force) in the off-gas passage and the gas flow flowing through the off-gas passage can cause the dew condensation water to be discharged naturally. Therefore, in addition to the aforementioned advantages, it is possible to prevent water from being retained in the off-gas passage including the buffer.

Furthermore, the fuel cell system according to this invention can be configured so that at least part of the off-gas passage is inclined so that dew condensation water which has formed dew condensation in the dew condensation promoting area can be moved from a potential area of obstruction that may cause obstruction of the off-gas passage by the dew condensation water and/or freezing of the dew condensation water. Since this configuration can prevent the dew condensation water from being held in the potential area of obstruction, it is possible to prevent obstruction at the potential area of obstruction by the dew condensation water or frozen dew condensation water. In this case, it is also possible to more effectively prevent the dew condensation water from being attached to, and freezing in, the freezing-affected area by placing the dew condensation promoting area in a lower area (relative to the direction of gravitational force) than the freezing-affected area.

Incidentally, an example of the potential area of obstruction that may cause obstruction of the off-gas passage by the dew condensation water and/or freezing of the dew condensation water includes a comparatively narrow passage part of the off-gas passage whose diameter almost corresponds with the diameter of water drops of the dew condensation water.

Furthermore, with the fuel cell system according to this invention, hydrophilic processing may be applied to at least one of a surface of the dew condensation promoting area and a surface of the potential area of obstruction that may cause obstruction of the off-gas passage by freezing of the dew condensation water. This configuration can reduce surface tension of the dew condensation water, prevent the diameter of water drops from increasing, and further prevent obstruction of the off-gas passage with the dew condensation water. Discharge of the dew condensation water can be further promoted.

### Advantageous Effect of the Invention

The fuel cell system according to this invention can inhibit dew condensation in a freezing-affected area, which is an area affected by freezing, by providing a dew condensation promoting area for actively promoting dew condensation. As a result, it is possible to provide a fuel cell system that can prevent the freezing-affected area from freezing, enhance electrical efficiency, and enhance reliability.

### BRIEF DESCRIPTION OF THE DRAWINGS

FIG. 1 is a diagrammatic illustration showing part of a fuel cell system according to an embodiment of this invention;

FIG. 2 is an enlarged sectional view of the fuel cell system shown in FIG. 1 in the vicinity of a pressure sensor placed in an oxidant gas discharge passage (off-gas passage);

FIG. 3 is an enlarged fragmentary sectional view of part of the fuel cell system shown in FIG. 1;

FIG. 4 shows temperature distribution of the oxidant gas discharge passage in the fuel cell system, shown in FIG. 1;

FIG. 5 is an enlarged sectional view of an area around a pressure sensor placed in an oxidant gas discharge passage of a fuel cell system according to another embodiment of this invention;

FIG. 6 is an enlarged fragmentary section view of part of a fuel cell system according to another embodiment of this invention;

FIG. 7 is an enlarged sectional view showing an example of a dew condensation promoting area located in an oxidant gas discharge passage in a fuel cell system according to another embodiment of this invention;

FIG. 8 is a diagrammatic illustration showing part of a fuel cell system according to another embodiment of this invention; and

FIG. 9 is a diagrammatic illustration showing part of a fuel cell system according to another embodiment of this invention.

### BEST MODE FOR CARRYING OUT THE INVENTION

Next, a fuel cell system according to preferred embodiments of this invention will be explained with reference to the attached drawings. While the embodiments described below are for the purpose of describing this invention, the invention is not limited only to these embodiments. Accordingly, this invention can be utilized in various ways unless the utilizations depart from the gist of the invention.

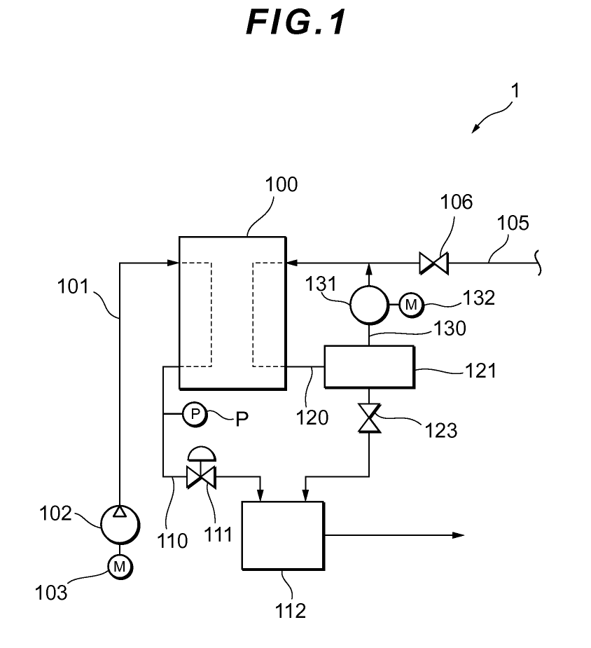

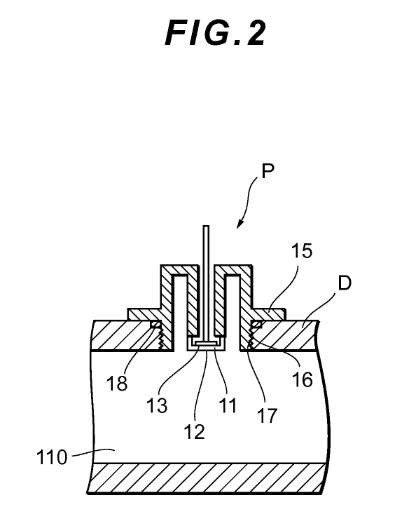

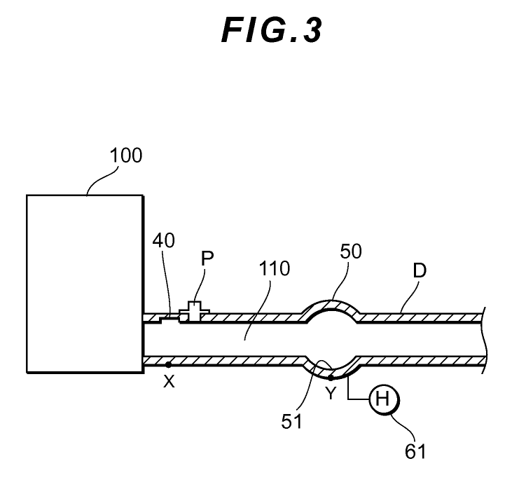

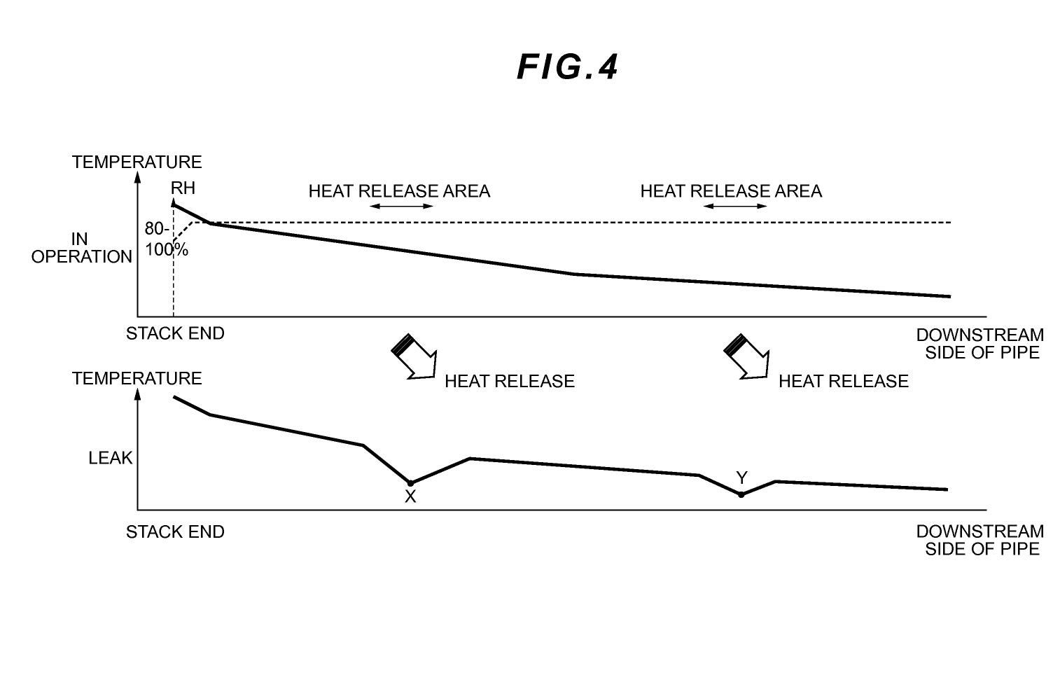

FIG. 1 is a diagrammatic illustration showing part of a fuel cell system according to an embodiment of this invention; FIG. 2 is an enlarged sectional view of the fuel cell system shown in FIG. 1 in the vicinity of a pressure sensor placed in an oxidant gas discharge passage; FIG. 3 is an enlarged fragmentary sectional view of part of the fuel cell system shown in. FIG. 1; and FIG. 4 shows temperature distribution of the oxidant gas discharge passage in the fuel cell system shown in FIG. 1.

As shown in FIG. 1, a fuel cell system 1 according to an embodiment of this invention includes a fuel cell 100. This fuel cell 100 is connected with an oxidant gas supply passage 101 for supplying an oxidant gas (such as air) used for electric power generation to a stack for the fuel cell 100. An upstream part of this oxidant gas supply passage 101 is provided with an air compressor 102, which is an oxidant gas supply means, and a drive motor 103 for driving the air compressor 102. Also, the fuel cell 100 is connected to a fuel gas supply passage 105 for supplying a fuel gas (such as hydrogen) used for electric power generation to the stack for the fuel cell 100. A fuel gas supply device (not shown in the drawing) (for example, a high-pressure hydrogen-gas tank or a reformer for generating hydrogen by a reforming reaction) is placed upstream of the fuel gas supply passage 105 and the fuel gas supplied from this fuel gas supply device is supplied via a pressure-reducing valve 106 to the stack for the fuel cell 100.

The oxidant gas introduced into the fuel cell 100 and supplied to the passage on the cathode electrode side of the stack is used for an electrochemical reaction at each cell of the fuel cell and is then discharged from the fuel cell 100 through an oxidant gas discharge passage 110. The pressure of this discharged oxidant off-gas is measured by a pressure sensor P and regulated by a pressure regulating valve 111, and then sent to a diluter 112.

On the other hand, the fuel gas, which is introduced into the fuel cell 100 and supplied to the passage on the anode electrode side of the stack, is used for an electrochemical reaction at each cell of the fuel cell and is then discharged from the fuel cell 100 through a fuel gas discharge passage 120 and introduced into a gas-liquid separator 121. Part of the fuel off-gas introduced into this gas-liquid separator 121 is sent, together with moisture separated by the gas-liquid separator 121, to a diluter 112 and then made to join the oxidant off-gas sent from the oxidant gas discharge passage 110. Incidentally, a purge valve 123 is placed between the gas-liquid separator 121 and the diluter 112.

The gas-liquid separator 121 is connected to a fuel gas circulation passage 130. This fuel gas circulation passage 130 is provided with an electric compressor (fuel gas circulation pump) 131 and a drive motor 132 for driving the electric compressor 131. The pressure of the fuel off-gas discharged from the gas-liquid separator 121 is raised by the electric compressor 131 and then made to join the fuel gas, which is supplied from the fuel gas supply device, and sent to the fuel cell 100 again.

The pressure sensor P placed at the oxidant gas discharge passage 110 includes, as shown in FIG. 2, a diaphragm 11, which serves as a pressure detector, a displacement sensor 13 attached to one surface of the diaphragm 11 opposite a pressure-receiving surface 12, and a fixture part 15 for securing the diaphragm 11 and the displacement sensor 13 to a pipe D that constitutes the oxidant gas discharge passage 110. The fixture part 15 has a screw part 17 that engages with a screw part 16 formed in the pipe D and the pressure sensor P is secured to the pipe D by engagement between the screw part 16 and the screw part 17. Incidentally, the reference numeral 18 represents a seal member for hermetically sealing the pipe D so that the oxidant off-gas will not leak out of the pipe D.

The pipe D made of, for example, a resin is preferably used. On the other hand, the pressure sensor P made of, for example, stainless steel is preferably used. However, in this embodiment, the fixture part 15 located around the diaphragm 11 is made of copper whose thermal conductivity (k) is low. Since ease of heat conduction is proportional to the thermal conductivity (k), it is more difficult for the fixture part 15, which is made of copper with low thermal conductivity (k) to conduct heat (or the fixture part 15 has larger heat resistance (R)), than it is for the pipe D.

A thin-walled part 40 whose wall thickness (L) is thinner than that of part of the pipe D where the pressure sensor P is located is formed upstream from, and near to, the pressure sensor P, as shown in FIG. 3. Since ease of heat conduction is inversely proportional to the wall thickness (L), it is easier for the thin-walled part 40 with a thin wall thickness (L) to conduct heat (or the thin-walled part 40 has lower heat resistance (R)), than it is for the position where the pressure sensor P is located.

Furthermore, a large-diameter part 50 whose diameter is larger than the part of the pipe D where the pressure P is located is formed downstream from, and near to, the pressure sensor P, as shown in FIG. 3. Therefore, the surface area (A) of the large-diameter part 50 is larger than that of the pipe D where the pressure sensor P is located. Since ease of heat conduction is proportional to the surface area (A), it is easier for the large-diameter part 50 with a large surface area (A) to conduct heat (or the large-diameter part 50 has lower heat resistance (R)), than it is for the part of the pipe D where the pressure sensor P is located. A buffer 51 composed of a recess capable of retaining water is formed at a lower part (or bottom face) of this large-diameter part 50.

Incidentally, the relationship between the heat resistance (R), the thermal conductivity (k), the wall thickness (L), the surface area (A), and the quantity of heat transfer (Q) is as described below. It should be noted that T_{H} represents the highest temperature and T_{L} represents the lowest temperature.

Q=(T_{H}−T_{L})/R

T_{H}=T_{L}+RQ=T_{L}+(L/kA)Q

As is apparent from the above formulas, it is only necessary to perform at least one of the following in order to promote the dew condensation: reducing the heat resistance (R), increasing the thermal conductivity (k), reducing the wall thickness (L), and increasing the surface area (A).

The oxidant off-gas containing moisture flows through the oxidant gas discharge passage 110; and if the fuel cell 100 is placed in a low-temperature environment, a cold oxidant off-gas flows. In this circumstance, the moisture contained in the oxidant off-gas may form dew condensation and freeze at the pressure sensor P. Particularly in the state where the fuel cell system 1 is stopped (in a soak state) and a high-temperature reactant gas is not flowing, moisture may freeze in this environment. If the pressure sensor P freezes, precise pressure measurement can no longer be guaranteed. Accordingly, the pressure sensor P is the freezing-affected area that will be adversely affected by freezing.

Referring to FIG. 4 showing the temperature distribution of the oxidant gas discharge passage 110, it can be understood that the temperature of the fuel cell 100 side (the stack side) is high while the fuel cell system 1 is in operation; and the more downstream a position in the oxidant gas discharge passage 110 is, the lower its temperature becomes. Since the outside air temperature is lower than the temperature of the oxidant gas discharge passage 110, the heat is released from the thin-walled part 40 and the large-diameter part 50 which can easily conduct heat; and while the fuel cell system 1 is in a soak state, the temperature of the thin-walled part 40 and the large-diameter part 50 decreases to be lower than the surrounding temperature (the temperature distribution at positions indicated with X and Y shows valley-like acute decline portions in the graph shown in FIG. 4) and dew condensation is formed at the thin-walled part 40 and the large-diameter part 50. In other words, the thin-walled part 40 and the large-diameter part 50 serve as dew condensation promoting areas where the dew condensation is promoted, compared to other portions of the pipe D; and it is comparatively difficult to form the dew condensation at the pressure sensor P which is the freezing-affected area. Incidentally, the X position and the Y position shown in FIG. 3 correspond to the X position and the Y position shown in FIG. 4.

Since the dew condensation water generated at the large-diameter part 50 is retained in the buffer 51, it is possible to prevent the dew condensation water from overflowing and moving from the dew condensation area and obstructing the oxidant gas discharge passage 110. Also, the dew condensation water generated at the thin-walled part 40 is blown off downstream by the flow of the oxidant off-gas and then retained in the buffer 51. The volume of this buffer 51 is set to a value equal to or greater than an amount of water calculated from the amount of saturated vapor that can exist in the oxidant gas discharge passage 110. The higher the operating temperature of the fuel cell is, the more the amount of water vapor increases. Therefore, the optimum volume of the buffer is calculated based on the temperature distribution at the highest operable temperature (T_{FCMAX}) by using equations of state of ideal gas in this embodiment. Specifically, the following equations are used:

PV=nRT_{FCMAX}

n=PV/RT_{FCMAX}

It should be noted that P represents saturated vapor pressure, V represents the volume, n represents the amount of vapor, R represents a gas constant, and T_{FCMAX} represents the highest operable temperature. The amount of vapor n₅₁ that can be retained in the buffer 51 is calculated by the following formula:

n₅₁=Σ(PV/RT_{FCMAX})

It is possible to reliably prevent the dew condensation water from overflowing from the buffer 51 by deciding the volume of the buffer 51 as described above.

A heater 61 is placed at the buffer 51 as shown in FIG. 3. This heater 61 heats only the precise spot of the buffer 51. The heater 61 is placed for the purpose of defrosting frozen dew condensation water when the temperature of an area around the buffer 51 becomes lower than freezing point and the dew condensation water retained the buffer 51 freezes. It should be noted that since the heater 61 is intended not to heat the whole oxidant gas discharge passage 110, but to heat only the precise spot of the buffer 51, temperature rise efficiency of the buffer 51 can be enhanced and energy costs required for heating can be reduced.

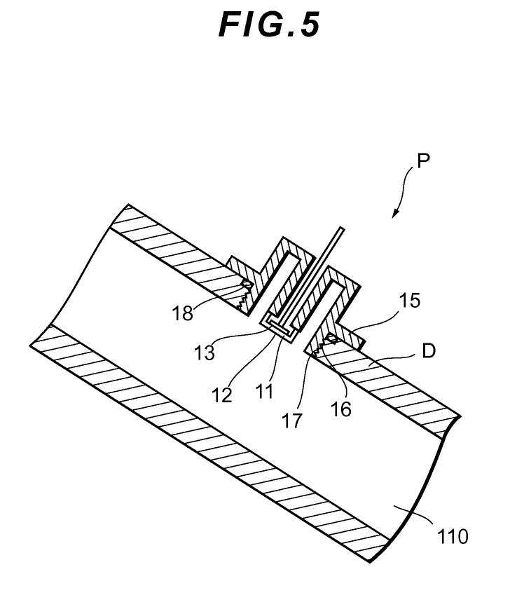

The pipe D which is placed horizontally in the above-described embodiment may be inclined so that its downstream side will be positioned lower than its upstream side as shown in FIG. 5. It is possible to make it easier for the buffer 51 to retain the dew condensation water, which has formed dew condensation at the thin-walled part 40, by inclining the pipe D as described above. If the pipe D is, inclined, the buffer 51 may not be provided and the dew condensation water which has formed dew condensation at the thin-walled part 40 and the large-diameter part 50, i.e., the dew condensation promoting areas, may be made to move downstream by the force of gravity and be discharged from the oxidant gas discharge passage 110 efficiently. In this case, the dew condensation water can be moved efficiently from the potential area of obstruction that may cause obstruction of the oxidant gas discharge passage 110 by the condensation water and/or freezing of the dew condensation water; and the dew condensation water can be prevented from being held in the potential area of obstruction. Therefore, it is possible to prevent the obstruction of the potential area of obstruction by the dew condensation water or the frozen dew condensation water.

Incidentally, the potential area of obstruction is not particularly shown in the drawing, but an example of the potential area of obstruction includes a comparatively narrow passage part of the off-gas passage 110 whose diameter almost corresponds with the diameter of water drops of the dew condensation water. Since the large-diameter part 50 is placed at a position lower (relative to the direction of gravitational force) than the pressure sensor P (on the downstream side in this embodiment) in this embodiment, hardly any dew condensation water which has formed dew condensation at the large-diameter part 50 will attach to the pressure sensor P, so it is possible to more reliably prevent the pressure sensor P from freezing due to the dew condensation water.

Furthermore, hydrophilic processing may be applied to the surfaces of the thin-walled part 40 and the large-diameter part 50 and the surface of the potential area of obstruction in the fuel cell system 1 according to this invention. This hydrophilic processing can reduce surface tension of the dew condensation water, prevent the diameter of water drops from increasing, further prevent the oxidant gas discharge passage 110 from being obstructed by the dew condensation water, and further promote discharge of the dew condensation water by the gas flow through the oxidant gas discharge passage 110.

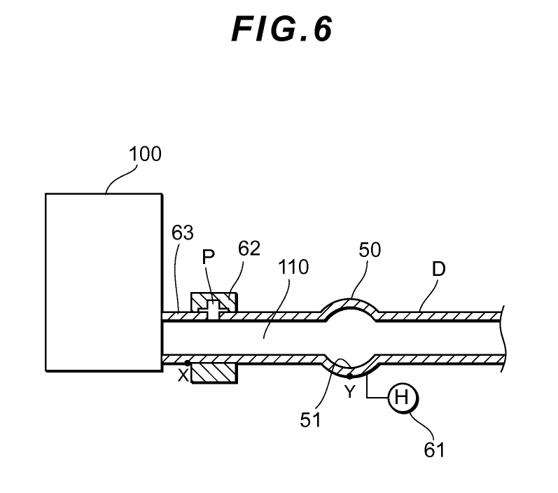

Incidentally, this embodiment has described the case where the dew condensation promoting area (the thin-walled part 40) is formed by reducing the wall thickness of the pipe D. However, the invention is not limited to this invention and, as shown in FIG. 6, a dew condensation promoting area 63 may be formed by placing a heat insulating material 62 at the pressure sensor P, which is the freezing-affected area, to increase the heat resistance of the pressure sensor P, thereby making the heat resistance of a surrounding area of the pressure sensor P relatively small.

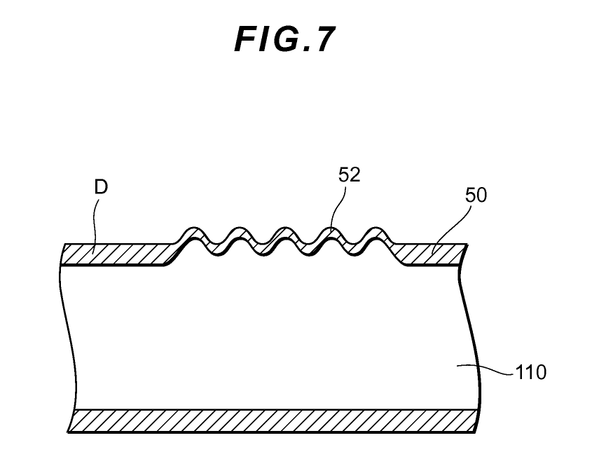

This embodiment has also described the case where the buffer 51 is placed at a lower part (relative to a vertical direction) (or bottom face) of the large-diameter part 50. However, the invention is not limited to this example and, as shown in FIG. 7, a buffer 52 may be placed at an upper part (relative to the vertical direction) (or ceiling face) of the large-diameter part 50. If the buffer 52 is placed at the upper part, and when the dew condensation water frozen at the buffer 52 is defrosted, the dew condensation water will fall downwards (relative to the direction of gravitational force) in the oxidant gas discharge passage 110 and can be naturally discharged by the gas flow through the oxidant gas discharge passage 110. As a result, this configuration like the aforementioned configuration can prevent the water from being retained in the oxidant gas discharge passage 110.

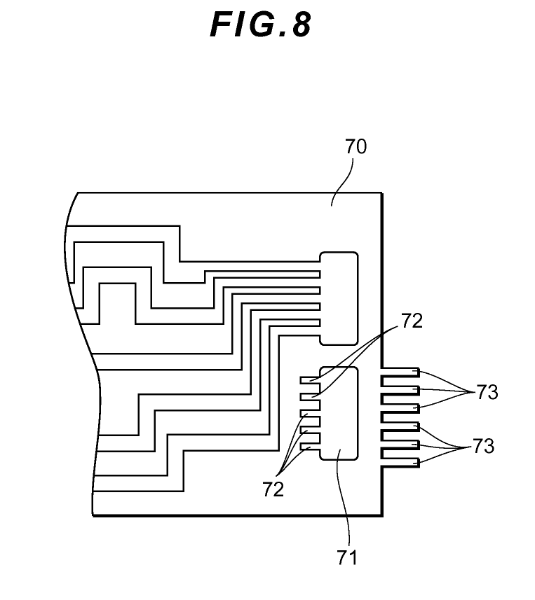

Furthermore, this embodiment has described the case where the freezing-affected area is the pressure sensor P. However, the invention is not limited to this example and an example of the freezing-affected area can include a comb-like passage 72 connected to a gas supply manifold and gas discharge manifold 71 formed in a separator 70 as shown in FIG. 8. In this case, a plurality of protrusions 73 may be formed with certain spaces between them on an end face of the separator 70 opposite the comb-like passage 72 to increase a surface area of this portion, thereby reducing the heat resistance and making it easier to form dew condensation than at the comb-like passage 72; and this portion can function as a dew condensation promoting area.

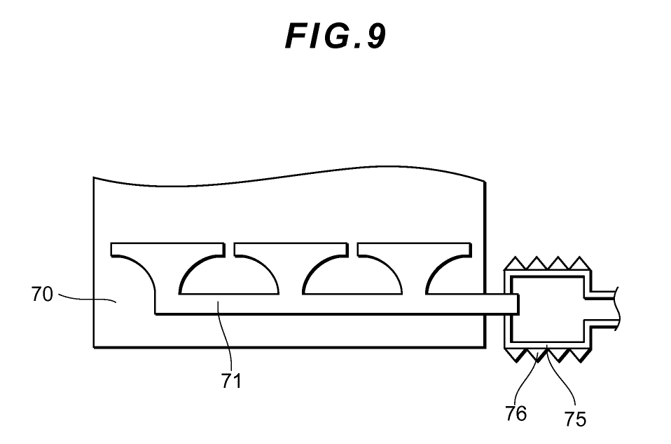

Furthermore, an example of the freezing-affected area can be a gas supply manifold and gas discharge manifold 71 formed in the separator 70 as shown in FIG. 9. In this case, an indented surface 76 is formed around the outside surface of an inlet of a buffer tube 75 made of stainless steel, which is connected to the manifold 71, to increase the surface area of this portion, thereby reducing the heat resistance and making it easier to form dew condensation than at the manifold 71; and this portion can function as a dew condensation promoting area.

Incidentally, the freezing-affected area is not particularly limited, and any area that will be adversely affected by freezing such as a common rail part, a valve, or a compressor can be treated as the freezing-affected area as the necessity arises. Also, any area can be the dew condensation promoting area as long as it is made comparatively easier to form dew condensation in that area by reducing the heat resistance to be lower than that of the freezing-affected area. A means for reducing (or lowering) the heat resistance is not particularly limited, and can include, for example, increasing the thermal conductivity, reducing the wall thickness, and increasing the surface area, as long as such means does not adversely affect the fuel cell system.

Furthermore, this embodiment has described the case where the freezing-affected area and the dew condensation promoting area are formed in the oxidant gas discharge passage 110. However, the invention is not limited to this example and the freezing-affected area and the dew condensation promoting area may be formed in the fuel gas discharge passage.

### DESCRIPTION OF REFERENCE NUMERALS

1 Fuel cell system
40 Thin-walled part
50 Large-diameter part
51, 52 Buffers
61 Heater
62 Heat insulating material
63 Dew condensation promoting area
72 Comb-like passage
73 Protrusions
76 Indented surface
100 Fuel cell
110 Oxidant gas discharge passage
D Pipe
P Pressure sensor

1. A fuel cell system comprising a fuel cell and an off-gas passage for allowing off-gas discharged from the fuel cell to flow through,
wherein a dew condensation promoting area for promoting dew condensation is placed around a freezing-affected area that will be adversely affected by freezing.

2. The fuel cell system according to claim 1, wherein the dew condensation promoting area has lower heat resistance than that of the freezing-affected area.

3. The fuel cell system according to claim 1, wherein the dew condensation promoting area is provided with a buffer capable of temporarily retaining dew condensation water.

4. The fuel cell system according to claim 3, wherein the dew condensation promoting area is placed in the off-gas passage, and
the buffer is placed in an area whose temperature becomes lower than a surrounding temperature when temperature distribution in the off-gas passage is measured.

5. The fuel cell system according to claim 3, wherein the buffer is provided with a heater.

6. The fuel cell system according to claim 1, wherein a volume of the buffer is equal to or greater than an amount of water calculated from an amount of water vapor that can exist in the off-gas passage.

7. The fuel cell system according to claim 1, wherein the buffer is placed in an upper area, relative to a direction of gravitational force, of the off-gas passage.

8. The fuel cell system according to claim 1, wherein at least part of the off-gas passage is inclined so that dew condensation water which has formed dew condensation in the dew condensation promoting area is moved from a potential area of obstruction that may cause obstruction of the off-gas passage by the dew condensation water and/or freezing of the dew condensation water.

9. The fuel cell system according to claim 8, wherein the dew condensation promoting area is placed in a lower area, relative to a direction of gravitational force, than the freezing-affected area.

10. The fuel cell system according to claim 1, wherein hydrophilic processing is applied to at least one of a surface of the dew condensation promoting area and a surface of a potential area of obstruction that may cause obstruction of the off-gas passage by freezing of dew condensation water.
